(19) United States
(12) Patent Application Publication
(10) Pub. No.: US 2018/0163956 A1
(43) Pub. Date: Jun. 14, 2018

(54) ATTACHABLE LIGHTING SYSTEM

(71) Applicant: APOLLO ENERGY SERVICES CORP., Crossfield (CA)

(72) Inventor: Matthew GOWANLOCK, Airdrie, Alberta (CA)

(73) Assignee: APOLLO ENERGY SERVICES CORP., Crossfield, AB (CA)

(21) Appl. No.: 15/736,156

(22) PCT Filed: Jul. 20, 2016
(86) PCT No.: PCT/IB2016/054329

§ 371 Date: Dec. 13, 2017

Related U.S. Application Data
(60) Provisional application No. 62/196,556, filed on Jul. 24, 2015.

(51) Int. Cl. F21V 21/116; F21V 21/30; E21B 41/00

(52) U.S. Cl. CPC F21V 21/116; F21W 2131/1005; E21B 41/00; F21V 21/30

(57) ABSTRACT

An attachable lighting system for a tower structure such as a drilling rig. A lighting system is described for a tower structure having at least one side. A lighting frame is attached to at least one side of the tower structure, the lighting frame including at least one light support bracket attached to the lighting frame for holding at least one lighting fixture. The system is attachable at any level of the tower, high or low.

### CROSS-REFERENCE TO RELATED APPLICATION

The instant application claims priority to U.S. Provisional Application No. 62/196,556, filed Jul. 24, 2015 and may relate to subject matter disclosed in one or more of U.S. patent applications Ser. No. 14/093,097, filed Nov. 29, 2013; Ser. No. 14/632,592, filed Feb. 26, 2015; Ser. No. 62/109,966, filed Jan. 30, 2015; and Ser. No. 62/127,020, filed Mar. 2, 2015. The entirety of each of the aforementioned applications is specifically incorporated herein by reference for all purposes.

### TECHNICAL FIELD

The present invention relates generally to the field of lighting systems, and in particular to lighting systems for use with oil drilling, mining, construction and any operations utilizing mobile lighting equipment

### BACKGROUND

Drilling rigs are used to form wellbores for the purpose of extracting oil, natural gas or other fluids from subsurface deposits. Drilling rigs can also be used for sampling subsurface mineral deposits, testing rock or ground fluid properties and for installing subsurface utilities, instrumentations, tunnels or wells. In implementation, drilling rigs may be mobile equipment transportable by truck, rail, trailers, or similar, rigs may also be semi-permanent and permanent fixtures as in the case for oil drilling of large wells. Marine-based structures are also widely known. Generally, the term drilling rig refers to an arrangement of equipment that is used to penetrate the subsurface of the earth's crust.

Drilling operations typically occur during daylight hours and visibility in and around the drilling rig has historically only been required when manual work is being done, inspection and calibration, for example. There is a desire to increase productivity by providing visibility during hours of low daylight, and this has thus far been accomplished by providing mobile lighting arrangements on vehicles proximate the drilling rig, or otherwise manually adding impromptu lighting arrangements around the drilling rig. And while this is particularly important in the area of drilling rigs, it is an issue for work areas in general where towers are needed or used.

These arrangements are generally inadequate and not readily adaptable to systematic visibility improvements in appropriate locations around a drilling rig.

### BRIEF SUMMARY

A lighting system for a tower structure is described including a tower structure having at least one side section, a lighting frame attached to the at least one side section of the drilling rig, where the lighting frame includes at least one light support bracket attached to the lighting frame for holding at least one lighting fixture, and at least one lighting fixture attached to each light support.

Additional embodiments include: The lighting system described above where the lighting frame is removably attached to at least one side section of the tower structure; the lighting system described above where the light support bracket has a central axis, is adjustable around the central axis, and can rotate up to 360° degrees around the central axis; the lighting system described above where the light support bracket includes at least one arm section supporting at least one lighting fixture, and the arm section includes at least one connection point for at least one lighting fixture, and at least one lighting fixture is adjustable in a vertical direction around the connection point; the lighting system described above where the lighting frame is attached to at least one side of the tower structure by pinning lugs attached to at least one side of the tower structure; the lighting system described above where the pinning lugs are permanently attached to at least one side of the tower structure; the lighting system described above where the pinning lugs are welded to at least one side of the drilling rig; the lighting system described above where the lighting frame is attached to at least one side of the drilling rig through pinning lugs attached to the lighting frame; the lighting system described above where the lighting frame is attached to at least one side of the tower structure by pins extending through the pinning lugs attached to the lighting frame and through the pinning lugs attached to at least one side of the tower structure; the lighting system described above where the tower structure has up to four side sections; the lighting system described above where the lighting frame contains up to 96 lighting fixtures; the lighting system described above where the lighting frame contains a first lighting bar arranged horizontally parallel and above a second lighting bar; the lighting system described above where each lighting bar contains up to 16 lighting fixtures; and, the lighting system described above where the tower structure is a drilling rig.

A lighting system particularly adapted to be attached to a tower structure is also described including a lighting frame attachable at least one side section of a tower structure, the lighting frame including at least one light support bracket attached to said lighting frame for holding at least one lighting fixture, and at least one lighting fixture attached to each light support.

These, and additional embodiments, will be apparent from the following descriptions.

### BRIEF DESCRIPTION OF THE DRAWINGS

Embodiments will now be described, by way of example only, with reference to the attached Figures, wherein:

FIG. 1 is a perspective view of a lighting system mounted on a drilling rig according one embodiment of the invention.

FIGS. 2, 3A, 3B and 4 are expanded views of the embodiment of FIG. 1.

### DETAILED DESCRIPTION

The particulars shown herein are by way of example and for purposes of illustrative discussion of the various embodiments of the present invention only and are presented in the cause of providing what is believed to be the most useful and readily understood description of the principles and conceptual aspects of the invention. In this regard, no attempt is made to show details of the invention in more detail than is necessary for a fundamental understanding of the invention, the description making apparent to those skilled in the art how the several forms of the invention may be embodied in practice.

The present invention will now be described by reference to more detailed embodiments. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise. All publications, patent applications, patents, and other references mentioned herein are expressly incorporated by reference in their entirety.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Every numerical range given throughout this specification will include every narrower numerical range that falls within such broader numerical range, as if such narrower numerical ranges were all expressly written herein.

Additional advantages of the invention will be set forth in part in the description which follows, and in part will be obvious from the description, or may be learned by practice of the invention. It is to be understood that both the foregoing general description and the following detailed description are exemplary and explanatory only and are not restrictive of the invention, as claimed.

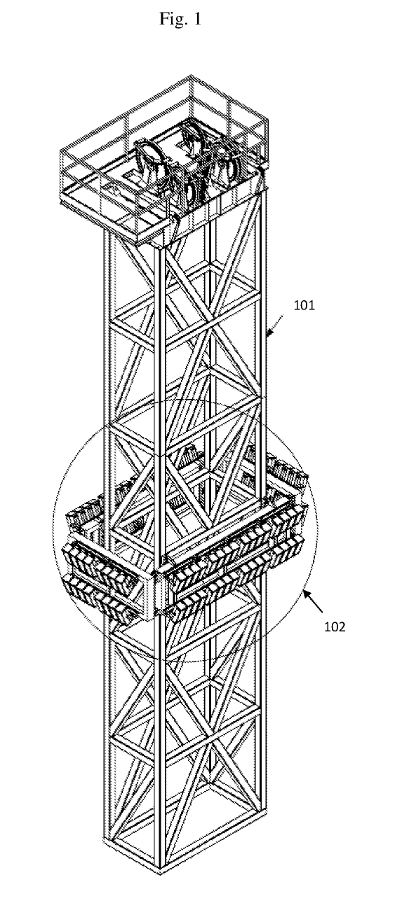

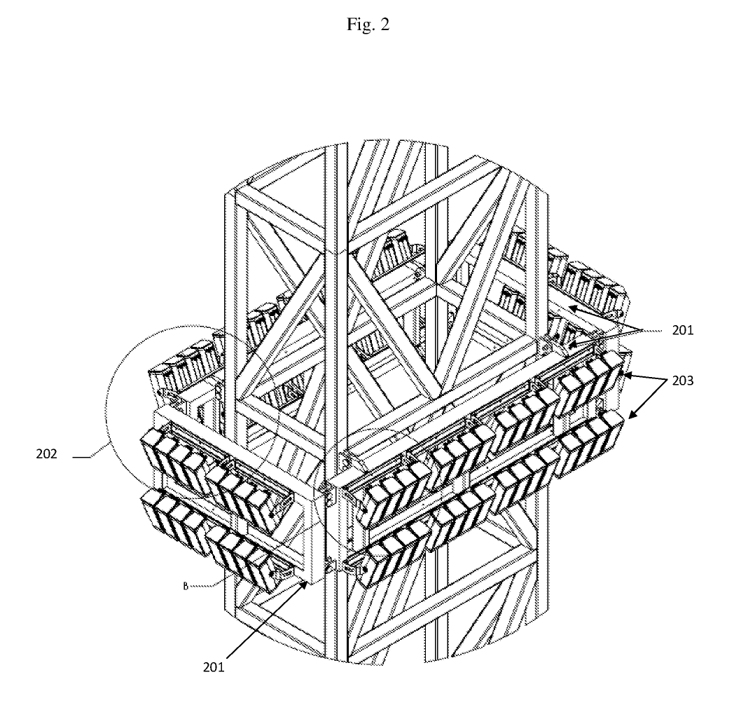

Referring to FIGS. 1 to 4, a typical drilling rig frame structure (101) is shown (here with four sides enclosed) with one embodiment of the lighting system described herein (102) attached thereto. Typically lighting is provided in these environments with separate, standalone structures, which generally produce unwanted shadows in the work areas and can also require their own or separate power generators. The lighting systems described herein light up the surrounding work area (commonly referred to as the “Lease”) to allow for safe working lighting levels around all of the rigs and its support equipment, And while FIGS. 1 and 2 show a representative lighting system with 96 lighting fixtures (24 lighting groups, with 4 lights in each group) any number of lighting fixtures can be used depending on the size of the area to be lit up, the amount of lighting required for the type of work being done, the degree of darkness present when the work needs to be done, etc. So, for example, a single row of lights could be used instead of the double rows shown in the figures, and lesser numbers per row, for example, half the number of lights in each row, or four lights per side, etc. These systems are attached to the tower itself, and at heights which can be customized to accommodate the particular needs and purposes of the user. They can also use the power source being provided to the rig itself without the requirement for separate power generators to power the lights themselves. And while the lighting systems described herein can be attached to less than four sides, e.g. one two or even three sides, the systems shown in the figures are attached to all four sides.

While drilling rig structures provide a particularly useful environment for the use of the lighting systems described herein, any tower system requiring lighting to an area will find the lighting system described herein useful. Also, the pieces or bars containing the lighting fixtures can be attached to one side at a time, again allowing for attachment to one, two, three or four sides, in one, two or more multiple rows, above and/or below the first row attached.

In addition to the customization of the height selected to accommodate user lighting needs, for example, selecting a height higher up to reduce shadows, the height can also be selected so as to accommodate the lifting power of the equipment being used to lift the rig from its normal horizontal transport position to its vertical use position. See, for example, the patent applications cited above, the disclosures of which are herein incorporated by reference. The lower the mounting position of the lights on the rig tower, the less power it will take to lift the tower. Typically the lighting system described herein and shown in FIG. 1, will be located between about 20 to about 40 feet below the top of the tower, but as described above, any height can be selected with such things as lighting requirements, elimination of shadows, tower lifting power requirements, etc. in mind. And as mentioned, the lower locations on the tower can reduce lifting requirements (for example, for older rigs) of the rig dramatically.

In addition, while four light banks containing four lights per bank are shown on all four sides in the figures, any combination of lights can be used. For example, a single light, a double light bank, a triple light bank, etc. could be mounted on a single side, or more than one side, as well as multiple light banks, whether single or multiple, or combinations thereof, could be mounted on one or more sides as desired to accommodate the individual lighting needs of the user.

FIG. 2, which depicts an expanded view of the lighting system (102) shown in FIG. 1, shows four light banks of four lights attached to the frame, with a second row juxtaposed just above (or below) the other. As mentioned above, this is just one of the lighting arrangements which can be used with the lighting systems described herein. Any number of rows of lights can be attached above and below one another, with any number of lights on each bar, attached to as many sides as desired to accommodate the specific needs of the user. For example, one area below the rig may require more lighting than others, but the desire may be to have some lighting on all sides, or only on two sides, or one side, etc. And again, as mentioned, it is also not necessary to have all bars at the same height on each side, or on any side for that matter, again to accommodate user needs. So each lighting system as described herein has the flexibility and can be customized to meet the needs of each individual rig use.

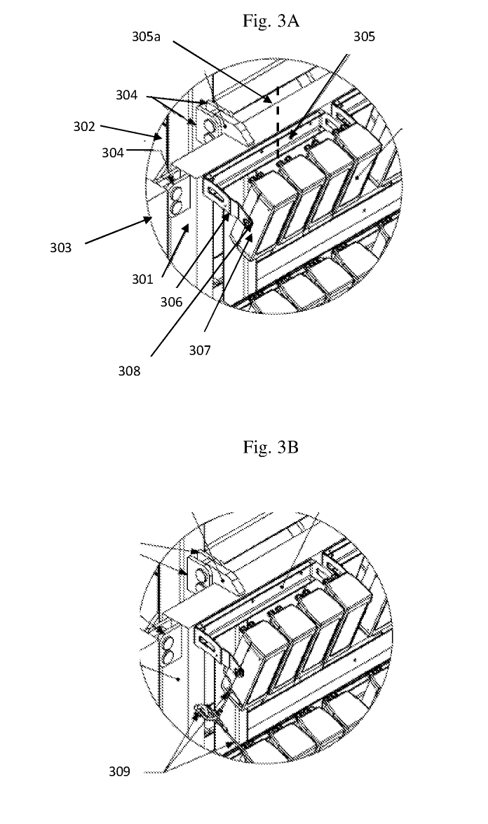

The lighting frames (201) depicted in FIG. 2 are shown as lighting bars (203) containing two rows of four light banks, with four lights in each bank, i.e., a total of 16 lights per bar. The hook and pin connections (202) for securing the light bank to the rig are depicted in an expanded view in FIGS. 3A,3B and 4.

In FIG. 3A, the light bar frame (301) is shown attached to the drilling rig frame or derrick (302) and to an additional lighting frame (303) through hook and pin structural connection points (304). While these pinning lugs (304) will typically be attached by welding, of course other conventional methods of attachment can also be employed, such as the use of conventional bolts, clamps, etc. Also depicted are the rotating swivel bracket connectors (305) having a central axis (305a) which allows the light bank to swivel basically in a 360° direction around the central axis. This coupled with the side arm section (306) of the brackets allow adjustment of the lights (307) around the connection point (308) in the light bank in a vertical direction as well, accommodating a full range of motion for the lights to again accommodate in fine detail the lighting directions for the user. In FIG. 3B the cable is shown attached typically by an eye-bolt or lug to the frame for secondary security as described below.

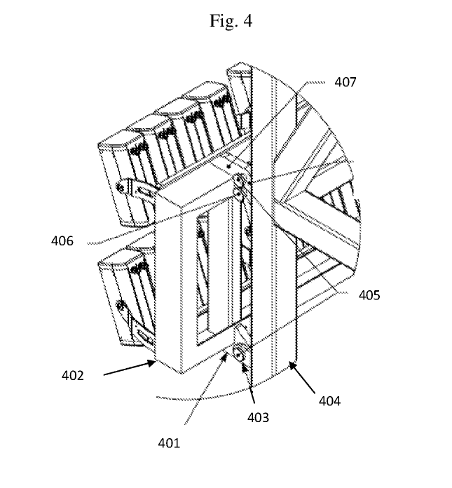

In FIG. 4, a perspective view of the attached light bank from another (rear) view, the bottom pinning lug (401) on the light frame (402) is attached to the (welded) pinning lug (403) attached to the drilling rig frame (404). The light frame securing pins (405) which are removable, secure the light frame to the drilling rig frame once they are put in place. The fixed pins (406) that the light bar frame hooks onto during attachment to the drilling rig frame. The fixed pins are there to allow the unit to hook onto them while being installed (hook and pin setup). This helps guide the unit into place without the need to guide it into place, lessening the potential safety hazard associated with having to guide it into place. The top pinning lug (407) on the light frame bar are also shown. Of note, since the light frames can be removably attached to the drilling rig frame, a series of securing pinning lugs can be attached to the drilling rig frame at different locations, to accommodate a change in lighting direction, intensity, etc. requirements if the drilling lighting requirements should change, either at a particular site, or as the drilling site changes.

In addition to the benefits described above, the lighting system described herein also at least meets, and in most cases exceeds, all well-known drop safety standards developed in the industry, i.e., to help prevent falling objects from causing injuries to those below. Such injuries typically occur be due to a variety of reasons, for example, due to piece connector items such as bolts coming loose on the rig. With the system described herein, the attaching pieces, such as bolts are securely fastened through the pin and lug system described, to help prevent such connector pieces from coming loose from vibration, etc. In addition, Nord-Lock washers can also be used on all hardware to help secure the hardware, for example, to help secure the hardware when used in a vibration environment. Further, if desired, a secondary containment system can also be used on all the lights in case the main bracket should fail for some reason (see, for example, securing cable 30_in FIG. 3 which can assist in securing the lighting system). And further still, in addition to the above, conventional drop safe nets can be included around each light fixture to help secure them to the frame in a “drop safe” manner as well. So multiple levels of protection can be integrated into the lighting system described herein to help meet and/or exceed well-known drop safety standards developed in the industry.

The scope of the claims should not be limited by the preferred embodiments set forth in description of the preferred embodiments or in the examples, but should be given the broadest interpretation consistent with the description as a whole.

1. A lighting system for a tower structure comprising:
a tower structure having at least one side section,
a lighting frame attached to the at least one side section of the tower structure, wherein, the lighting frame including at least one light support bracket attached to said
lighting frame for holding at least one lighting fixture; and,
at least one lighting fixture attached to each light support.

2. The lighting system according to claim 1, wherein the lighting frame is removably attached to at least one side section of the tower structure.

3. The lighting system according to claim 1, wherein the light support bracket has a central axis, is adjustable around the central axis, and can rotate up to 360° degrees around said central axis.

4. The lighting system according to claim 1, wherein the light support bracket includes at least one arm section supporting at least one lighting fixture, said arm section includes at least one connection point for said at least one lighting fixture, and said at least one lighting fixture is adjustable in a vertical direction around said connection point.

5. The lighting system according to claim 1, wherein the lighting frame is attached to the at least one side of the tower structure by pinning lugs attached to the at least one side of the tower structure.

6. The lighting system according to claim 5, wherein the pinning lugs are permanently attached to the at least one side of the tower structure.

7. The lighting system according to claim 6, wherein the pinning lugs are welded to the at least one side of the tower structure.

8. The lighting system of claim 5, wherein the lighting frame is attached to the at least one side of the tower structure through pinning lugs attached to the lighting frame.

9. The lighting system of claim 8, wherein the lighting frame is attached to the at least one side of the tower structure by pins extending through the pinning lugs attached to the lighting frame and through the pinning lugs attached to the at least one side of the tower structure.

10. The lighting system of claim 1, wherein the tower structure has up to four side sections.

11. The lighting system of claim 1, wherein the lighting frame contains at least four lighting fixtures.

12. The lighting system of claim 1, wherein the lighting frame contains up to 96 lighting fixtures.

13. The lighting system of claim 12, wherein the lighting frame contains a first lighting bar arranged horizontally parallel and above a second lighting bar.

14. The lighting system of claim 13, wherein each lighting bar contains up to 16 lighting fixtures.

15. The lighting system of claim 1, wherein the tower structure is a drilling rig.

16. A lighting system particularly adapted to be attached to a tower structure, comprising,
a lighting frame attachable at least one side section of a tower structure, the lighting frame including at least one light support bracket attached to said
lighting frame for holding at least one lighting fixture; and,
at least one lighting fixture attached to each light support.
